(19) United States
(12) Patent Application Publication
(10) Pub. No.: US 2008/0158186 A1
(43) Pub. Date: Jul. 3, 2008

(54) METHOD FOR INPUTTING CHARACTER

(75) Inventors: Tony Tsai, Taipei (TW); Xu-Dong Chen, Shanghai City (CN); Yao Feng, Shanghai City (CN)

Correspondence Address: J C PATENTS, INC., 4 VENTURE, SUITE 250, IRVINE, CA, 92618, US

(73) Assignee: INVENTEC APPLIANCES CORP., Taipei (TW)

(21) Appl. No.: 11/765,835

(22) Filed: Jun. 20, 2007

(30) Foreign Application Priority Data
Dec. 29, 2006 (TW) 95150004

(51) Int. Cl. G06F 3/041

(52) U.S. Cl. 345/173

(57) ABSTRACT

A method for inputting characters is provided. In the present invention, a touch-sensitive keypad is used for a hand-held electronic device to enter a text input mode. Multiple characters represented by a key are displayed by turns and repeatedly over a predefined period of time. Thus, the number of times for operating the keypad can be reduced and the efficiency of inputting characters can be improved. Further, the input of English alphabets and Arabic numerals can be switched automatically through alternatively displaying the characters. Therefore, the convenience of using a hand-held electronic device can be enhanced.

### CROSS-REFERENCE TO RELATED APPLICATION

This application claims the priority benefit of Taiwan application serial no. 95150004, filed Dec. 29, 2006. All disclosure of the Taiwan application is incorporated herein by reference.

### BACKGROUND OF THE INVENTION

1. Field of the Invention

The present invention is related to a method for inputting characters, and more particularly, to a method for inputting characters suitable for a handheld electronic device with a built-in, touch-sensitive keypad.

2. Description of Related Art

As the electronics industry develops and prospers, manufacturers not only try to develop multi-functional electronic products to satisfy consumer's demands, they also aim to develop smaller and lighter products. Over the recent years, hand-held communication devices are replacing traditional telephones, and becoming increasingly popular because today's hand-held communication devices are integrated with multiple functions such as telecommunication, camera and MP3 player. Further, hand-held communication devices are lightweight and portable.

However, when a user needs to input data into a portable, hand-held electronic device, the user relies on a keypad disposed on the hand-held electronic device. In comparison with the keypad for a personal computer, the size of the keypad disposed on the hand-held electronic device is limited by the volume of the device per se. Therefore, each key on the keypad preferably represents multiple characters at the same time, and the user needs to repeatedly press the same key to select the desired character to be inputted into the hand-held electronic device.

To take an ABC input method available in a mobile phone as an example, in this input method, each number key not only represents the Arabic numeral labeled on the key, but also represents three to four English alphabets (e.g. the number key “2” simultaneously represents English alphabets “a”, “b”, and “c”, and an Arabic numeral “2”, and the number key “3” simultaneously represents English alphabets “d”, “e”, and “f”, and an Arabic numeral “3”. If the user wishes to input the Arabic numeral “2” when editing a text message on the mobile phone, the user needs to press the number key “2” four times to complete the input. This type of repeated operation not only drastically lowers the convenience of using hand-held electronic devices, but also adversely affects the efficiency of inputting characters.

### SUMMARY OF THE INVENTION

Accordingly, the present invention is directed to a method for inputting characters adapted to reduce the number of times to operate the keypad when inputting characters in order to improve the efficiency of inputting characters.

The present invention is directed to a method for inputting characters that utilizes a touch-sensitive keypad to input characters into hand-held electronic devices. The method includes the following steps. First, a text input mode is entered according to a trigger event. Next, a plurality of characters are displayed by turns over a specific period of time. After exiting the text input mode, the character displayed last is inputted into the hand-held electronic device.

The present invention inputs characters through operating a touch-sensitive keypad to reduce the number of times required to operate the keypad, and improve the efficiency of inputting characters and the convenience of use.

In order to make the aforementioned and other objects, features and advantages of the present invention more comprehensible, preferred embodiments accompanied with figures are described in detail below.

### BRIEF DESCRIPTION OF THE DRAWINGS

FIG. 1 is a flowchart illustrating the method for inputting characters according to an embodiment of the present invention.

FIG. 2 is a schematic view illustrating a contact information interface according to an embodiment of the present- invention.

FIG. 3 is a schematic view illustrating a contact information interface according to an embodiment of the present invention.

FIG. 4 is a schematic view illustrating a contact information interface according to an embodiment of the present invention.

FIG. 5 is a schematic view illustrating a contact information interface according to an embodiment of the present invention.

FIG. 6 is a schematic view illustrating a contact information interface according to an embodiment of the present invention.

FIG. 7 is a schematic view illustrating a contact information interface according to an embodiment of the present invention.

### DESCRIPTION OF EMBODIMENTS

If the number of times required to operate a keypad (e.g. the number of times to press a key) when a user inputs a message into a hand-held electronic device is reduced, the efficiency of inputting characters and the convenience of use can definitely be improved. In view of the aforementioned, the present invention develops a method for inputting characters. In order to make the present invention more comprehensible, embodiments are described below as examples to prove that the invention can actually be realized.

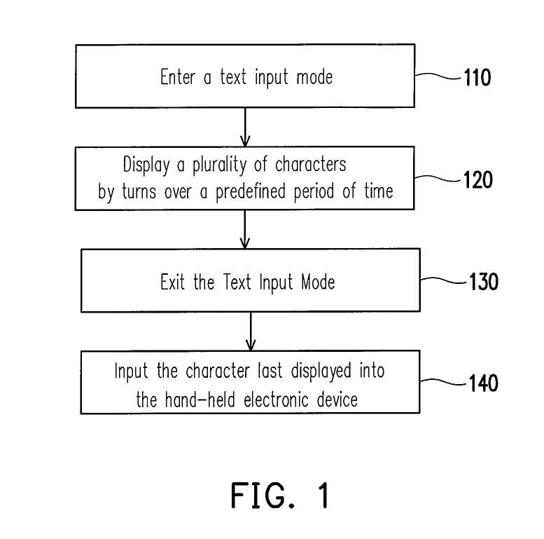

FIG. 1 is a flowchart illustrating the method for inputting characters according to an embodiment of the present invention. This embodiment details the steps for operating a touch-sensitive keypad to input characters into a hand-held electronic device. Herein, some examples of the hand-held electronic devices include mobile phones, personal digital assistant (PDA) phones, and smartphones that are installed with touch-sensitive keypad. However, the present invention is not limited thereto.

Referring to FIG. 1, after a user switches to an interface in a hand-held electronic device suitable for inputting characters and moves the cursor into an input region as shown in step 110, the hand-held electronic device enters a text input mode from a regular operation mode based on a trigger event. In the present embodiment, the trigger event is, for example, produced by a user touching the touch-sensitive keypad with a finger.

Next, as shown in step 120, after the hand-held electronic device enters the text input mode, a plurality of characters are displayed by turns in, for example, the input region, over a specific period of time. Herein, the aforementioned characters include English alphabets or Arabic numerals. However, the present invention is not limited thereto.

In step 130, when the hand-held electronic device exits the text input mode and returns to, for example, the regular operation mode, the character displayed last in the input region is considered as the character to be inputted and inputted into the hand-held electronic device (step 140).

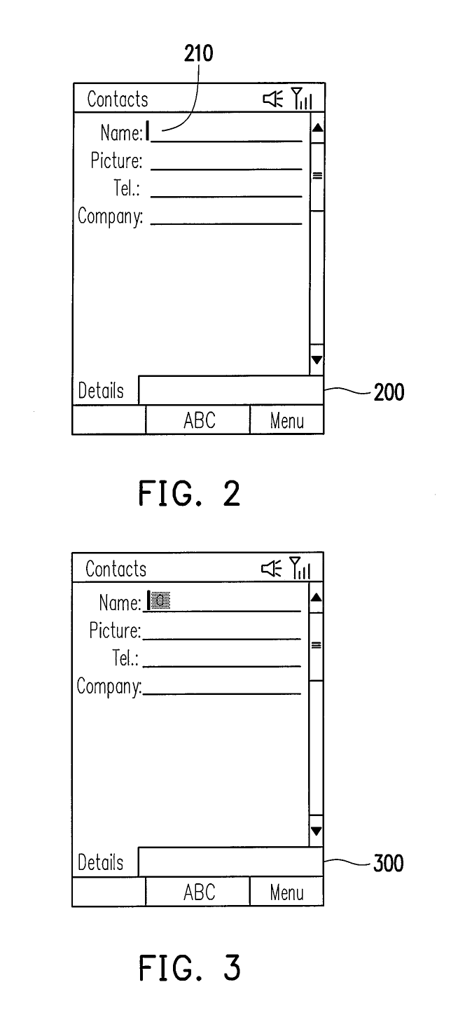

To further illustrate the steps of the method for operating the character input in the present invention, another embodiment is described below. In the present embodiment, a mobile phone disposed with a touch-sensitive keypad is used as an example. A user can operate such keypad through touching the keys. When the user wishes to input name information of a contact, the screen of the mobile phone is first switched to a contact information interface 200 as shown in FIG. 2. In the present embodiment, the initial position of the cursor is assumed to be right at a Name field 210, and the input method preset for this mobile phone is an ABC input method.

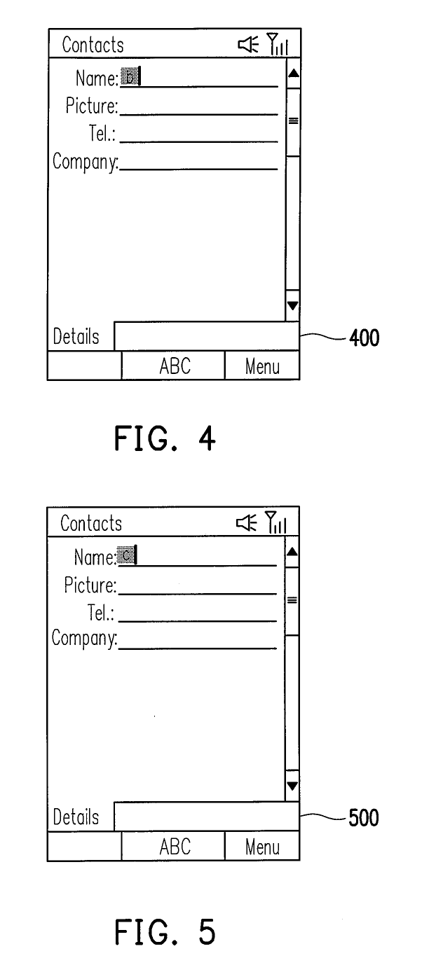

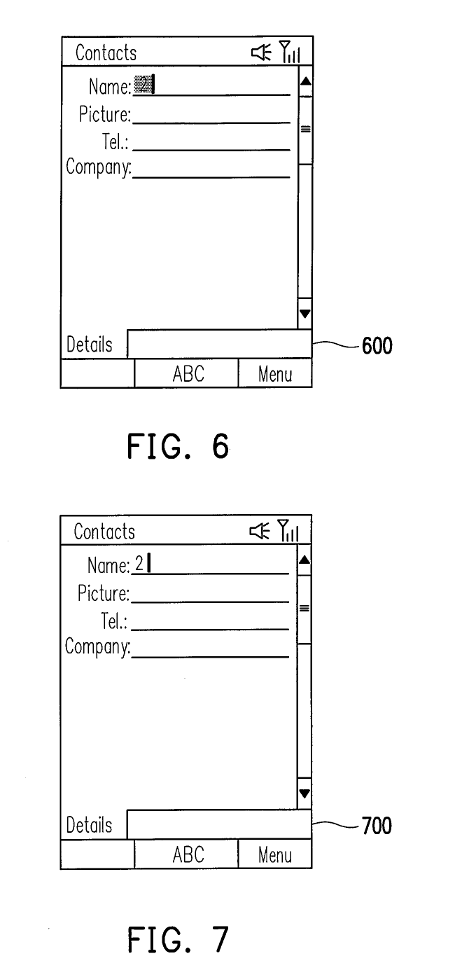

Next, when the user keeps touching a key on the touch-sensitive keypad for more than a first predefined period of time (e.g. 1 second), a trigger event is produced to make the mobile phone enter a text input mode. Herein, if the ABC input method is used as the input method, the number key “2” is used to represent English alphabets “a”, “b”, and “c”, and an Arabic numeral “2”. For example, if the number key “2” on the touch-sensitive keypad keeps being touched for more than 1 second, English alphabets “a”, “b”, and “c”, and an Arabic numeral “2” are displayed by turns at the cursor position on the Name field 210 as respectively shown in a contact information interface 300 of FIG. 3, a contact information interface 400 of FIG. 4, a contact information interface 500 of FIG. 5, and a contact information interface 600 of FIG. 6. It should be noted that, during the time when the user touches the number key “2”, all the characters represented by the number key “2” (i.e. English alphabets “a”, “b”, and “c”, and an Arabic numeral “2”) are displayed by turns at the cursor position on the Name field 210.

When the user finds the desired character (e.g. the Arabic numeral “2”) appears at the cursor position on the Name field 210, the user may release the number key “2” to exit the text input mode. When exiting the text input mode, the character displayed last at the cursor position on the Name field 210 is considered as the character to be inputted and inputted into the mobile phone to be part of the name information of the contact. The inputted result is shown in a contact information interface 700 of FIG. 7.

In the aforementioned embodiment, the user only needs to keep touching a key for more than a first predefined period of time, and the characters represented by the key are displayed by turns during the time that the key is touched. When the user finds the desired character, the user releases the key so as to accomplish the selection and the input of the character.

In another embodiment, the user, for example, may simply touch the touch-sensitive keypad to produce a trigger event for the mobile phone to switch from the regular operation mode to the text input mode. In the present embodiment, similarly, the input method preset for the mobile phone is assumed to be the ABC input method. After the user switches the interface of the mobile phone to the contact information interface 200 as shown in FIG.2 and moves the cursor to the Name field 210, when the user touches, for example, the number key “2”, the first character represented by the number key “2” (e.g. the English alphabet “a”) is instantaneously displayed at the cursor position as shown in the contact information interface 300 of FIG. 3.

In the mean time, when the user touches the number key “2” again within a second predefined period of time (e.g. 2 seconds), the second character represented by the number key “2” (e.g. the English alphabet “b”) replaces the character previously shown at the cursor position, resulting in the contact information interface 400 of FIG. 4. It should be noted that if the user stops touching the key for more than the second predefined period of time, the mobile phone exits the text input mode and returns to, for example, the regular operation mode. Further, the character displayed last at the cursor position is inputted to be part of the name information of the contact and stored to the mobile phone.

In view of the above, the character input method of the present invention has at least the following advantages:

1. A text input mode is entered by touching the touch-sensitive keypad, and a plurality of characters are displayed by turns over a predefined period of time to reduce the number of times required to operate the keypad and improve the efficiency of inputting characters.

2. A user can select and input English alphabets or Arabic numerals through simple operation without switching between input methods, thus improving the convenience of using hand-held electronic devices.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for inputting characters that utilizes a touch-sensitive keypad to input a character into a hand-held electronic device, comprising:
entering a text input mode according to a trigger event;
displaying at least one character by turns over a specific period of time;
exiting the text input mode and displaying a specific character, the specific character is the character displayed last over the specific period of time; and
inputting the specific character displayed last into the hand-held electronic device.

2. The method of claim 1, wherein the step for entering the text input mode according to the trigger event comprises:
consecutively touching a key of the touch-sensitive keypad for more than a first predefined period of time.

3. The method of claim 2, wherein the specific period of time comprises the period of time during which the key of the touch-sensitive keypad is touched.

4. The method of claim 3, wherein the step for displaying the characters by turns over the specific period of time comprises:
repeatedly displaying the characters represented by the key.

5. The method of claim 3, wherein the step for exiting the text input mode comprises:
releasing the key of the touch-sensitive keypad.

6. The method of claim 1, wherein the step for entering the text input mode according to the trigger event comprises:
touching a key of the touch-sensitive keypad.

7. The method of claim 6, wherein the specific period of time comprises an interval between two successive trigger events, wherein the specific period of time is smaller than or equal to a second predefined period of time.

8. The method of claim 7, wherein the step for displaying the characters by turns over a specific period of time comprises:
switching to display one of the characters represented by the key.

9. The method of claim 8, wherein the method for exiting the text input mode comprises:
releasing the key of the touch-sensitive keypad for more than the second predefined period of time.

10. The method of claim 1, wherein the characters comprise English alphabets and/or Arabic numerals.
